(19) United States
(12) Patent Application Publication
(10) Pub. No.: US 2017/0150032 A1
(43) Pub. Date: May 25, 2017

(54) CAMERA HAVING ADAPTIVE FUNCTIONALITY BASED ON CONNECTION WITH HOST DEVICE

(71) Applicant: Ieon C. Chenn, Laguna Hills, CA (US)

(72) Inventor: Ieon C. Chenn, Laguna Hills, CA (US)

(21) Appl. No.: 14/950,927

(22) Filed: Nov. 24, 2015

(51) Int. Cl. H04N 5/232; H04N 5/225

(52) U.S. Cl. CPC H04N 5/23206; H04N 5/2252; H04N 5/23245; H04N 5/23216

(57) ABSTRACT

A camera configured to operate in cooperation with a host device, wherein the camera detects the host device in response to connecting the camera to the host device, and implements operational functionality associated with the host device. The camera is adapted to operate autonomously and does not require input by a user.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field

The present disclosure relates generally to a camera, and more specifically to a camera adapted for use with a complimentary host device, with the camera being configured to detect the host device upon connection thereto and to implement functionality associated with the host device.

2. Description of the Related Art

The digital age has caused an evolution in the camera industry. In particular, cameras have evolved from being film-based to now being primarily digitally-based. Simple point-and-shoot digital cameras provided novice camera users with a simple, easy to use alternative to more complex, conventional film-based cameras. A traditional point-and-shoot digital camera generally included a button which the user pressed to snap a picture. By pressing the button, the camera automatically focused on an object and captured an image of the object on a digital sensor located within the camera. Traditional point-and-shoot digital cameras were also very compact, making them easy to carry.

The advent of smartphones brought about another evolution in the camera industry, by integrating the functionality of a conventional point-and-shoot digital camera into the smartphone. Images were captured in a manner to point-and-shoot, e.g., a user aims the camera lens at an object and presses/actuates a button, thereby causing the camera to automatically focus on the object and capture an image thereof. Furthermore, since users carried their smartphone with them throughout the day, individuals have become more inclined to capture the day-to-day moments by using the camera integrated into the smartphone. Once the image is captured, the inherent communication capabilities of the smartphone allowed users to easily share the captured images with friends and family.

Although digital point-and-shoot cameras, as well as smartphone cameras provide significant benefits and advantages to the end user, such digital cameras also suffer from certain deficiencies. For instance, while point-and-shoot and smartphone cameras have limited the amount of input required by the operator of the camera, such cameras still require a certain degree of operator input, e.g., aiming the camera, depressing/actuating a button, and selecting between various modes, such as video, picture, time-lapse, slow-motion, panoramic, etc. In this regard, operation of such cameras typically requires a degree of focus and concentration by the operator. However, in some instances, the operator may not want to divert his/her attention away from another activity to operate the camera. For example, if the operator is engaged in conversation or performing another activity, the user may not want to divert his attention toward operating the camera, and thus, it may be undesirable or difficult to operate the camera in such conditions.

Accordingly, there is a need in the art for a camera which is adapted to operate with little or no input from a human operator, and is adaptable for use in various operational modes depending on operative connection of the camera with a host device Various aspects of the present disclosure address this particular need, as will be discussed in more detail below.

### BRIEF SUMMARY

In accordance with one embodiment of the present disclosure, there is provided a camera configured to operate in cooperation with a host device, wherein the camera implements operational functionality associated with the host device in response to connecting the camera to the host device. In this respect, the camera is adapted to operate autonomously and does not require input by a user, and thus, stress or concern in relation to operation of the camera may be reduced or eliminated.

According to one embodiment, there is provided a method of operating an image capture assembly in connection with a host device. The method includes the steps of: receiving a first identification signal associated with a first host device at a processing circuit located within a camera housing, the processing circuit having multiple sets of command instructions stored thereon, each set of command instructions being associated with a respective host device and being operative to command the image capture assembly in accordance with a respective operational mode; identifying the particular set of command instructions associated with the first host device based on the first identification signal received therefrom; and operating the image capture assembly in accordance with the identified set of command instructions associated with the first host device.

The receiving, processing and/or operating steps may proceed independent of any input from a user. The operating step may occur autonomously in response to completion of the identifying step.

The first identification signal may be received at the processing circuit in response to connecting the camera housing to the first host device. The method may additionally comprise the step of operating the image capture assembly in accordance with default operational instructions in response to disconnection of the first host device from the camera housing.

The operating step may include operating the image capture assembly in a video mode and/or a picture-taking mode.

The first host device may be a GPS unit associated with the camera housing, and the first identification signal may be received at the processing circuit in response to the camera housing being within a prescribed geographic location.

The method may further comprise the steps of: receiving a second identification signal associated with a second host device at the processing circuit located within the camera housing; identifying the particular set of command instructions associated with the second host device based on the second identification signal received therefrom; and operating the image capture assembly in accordance with the identified set of command instructions associated with the second host device.

The method may additionally include receiving a power signal from the first host device.

According to another embodiment, there is provided a method of operating an image capture assembly in connection with a host device, wherein the method includes receiving an operating signal associated with a first host device at a camera. The camera includes an image capture assembly capable of being operated in a first operational mode and a second operational mode, and a microprocessor in operative communication with the image capture assembly and adapted to execute computer executable instructions for operating the image capture assembly in the first operational mode and the second operational mode based on the operating signal received by the camera. The method further includes determining which one of the first operational mode and the second operational mode is associated with the first host device and operating the image capture assembly in the one of the first operational mode and the second operational mode determined to be associated with the first host device.

The first operational mode may include operating the image capture assembly in a picture-taking mode and the second operational mode may include operating the image capture assembly in a video-taking mode.

The operating signal may include operational instructions associated with the first host device. The operating signal may also include identifying information associated with the first host device.

According to yet another embodiment, there is provided a camera adapted for use with a host device, with the camera comprising a camera housing and an image capture assembly coupled to the camera housing and including a lens and a shutter, the image capture assembly capable of being operated in a plurality of operational modes. A connector is coupled to the camera housing and is configured to be selectively connectable to a first host device. A processing circuit is operatively coupled to the connector and the image capture assembly, the processing circuit includes computer executable instructions stored thereon to enable the processing circuit to: identify the first host device when the first host device is connected to the connector; and operate the image capture assembly in accordance with the plurality of operational modes associated with the first host device.

The computer executable instructions stored on the processing circuit may enable operation of the image capture assembly in the first one of the plurality of operational modes associated with the first host device independent of any input by a user. The computer executable instructions stored on the processing circuit may enable operation of the image capture assembly in the first one of the plurality of operational modes associated with the first host device autonomously in response to identification of the first host device.

The camera may be formed independent of a button in operative communication with the processing circuit.

The computer executable instructions stored on processing circuit may enable the processing circuit to identify the first host device solely in response to information received from the first host device via the connector.

The processing circuit may be located within the camera housing.

According to yet another embodiment, there is provided an autonomously operated camera adapted for use with a host device. The autonomously operated camera includes an image capture assembly including a camera lens and a camera shutter. A data port is operatively coupled to the image capture assembly and is adapted to receive a first identification signal from a first host device when the first host device is operatively coupled to the data port. A processing circuit is in operative communication with the image capture assembly and the data port, with the processing circuit having computer executable instructions which allow the processing circuit to autonomously operate the image capture assembly solely in accordance with the first identification signal.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a schematic illustration of one embodiment of a camera adapted to operate autonomously in accordance with an operational mode associated with one of a plurality of host devices;

FIG. 2 is an upper perspective view of an embodiment of a male connector associated with a host device a female connector associated with the camera;

FIG. 3 is a side view of the male and female connectors shown in FIG. 2;

FIG. 4 is a perspective view of the female connector shown in FIGS. 2 and 3;

FIGS. 5A-5B provide a flowchart providing a method of using the camera according to one embodiment;

FIG. 6 is a schematic view of an image conversion module for converting image data generated by an image capturing assembly and transmitted by a wireless communication circuit;

FIG. 7 is an exemplary flowchart associated with converting image data based on a power signal received from the host device;

FIG. 8 is a schematic view of a smartphone display screen associated with programming the camera via the smartphone;

FIG. 9 is a perspective view of an embodiment of the camera connected to a host device in the form of a protective smartphone case having an extension arm;

FIG. 10 is a perspective view of an embodiment of the camera connected to a windshield mount;

FIG. 10A is a perspective view of a diagnostic dongle connectable to a diagnostic port on the vehicle depicted in FIG. 10 and operatively connectable to the camera shown in FIG. 10;

FIG. 11 is an enlarged view of the windshield mount and camera depicted in FIG. 8, with the camera being detached from the camera mount; and

FIG. 12 is a perspective view of an embodiment of the camera connected to a pet collar.

Common reference numerals are used throughout the drawings and the detailed description to indicate the same elements.

### DETAILED DESCRIPTION

The detailed description set forth below in connection with the appended drawings is intended as a description of certain embodiments of a camera having adaptive functionality based on its connection with a particular host device, and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

Various aspects of the present disclosure pertain to a camera 10 specifically configured and adapted for use with a host device 12, such that the functions implemented by the camera 10 may be varied depending on the particular host device 12 to which the camera 10 is connected. In this respect, the camera 10 may be adapted to operate in a plurality of different operational modes, such as several different video modes and several different picture taking modes, with each host device 12 being associated with a particular operational mode. The camera 10 may be able to detect and recognize each host device 12 when the host device 12 is operatively connected to the camera 10, and then implement the specific functionalities of the operational mode associated with the detected host device 12. Thus, by operatively connecting the camera 10 to a host device 12, the camera 10 may operate autonomously, e.g., without user input, and implement the specific functions associated with the host device 12. Accordingly, operation of the camera 10 may be varied by connecting the camera 10 to different host devices 12, with such operation proceeding without the need of a user to depress a button or make any other manual gesture to actuate the camera 10, e.g., the camera 10 may operate independent of user input, and thus, may be formed without a physical button or virtual button.

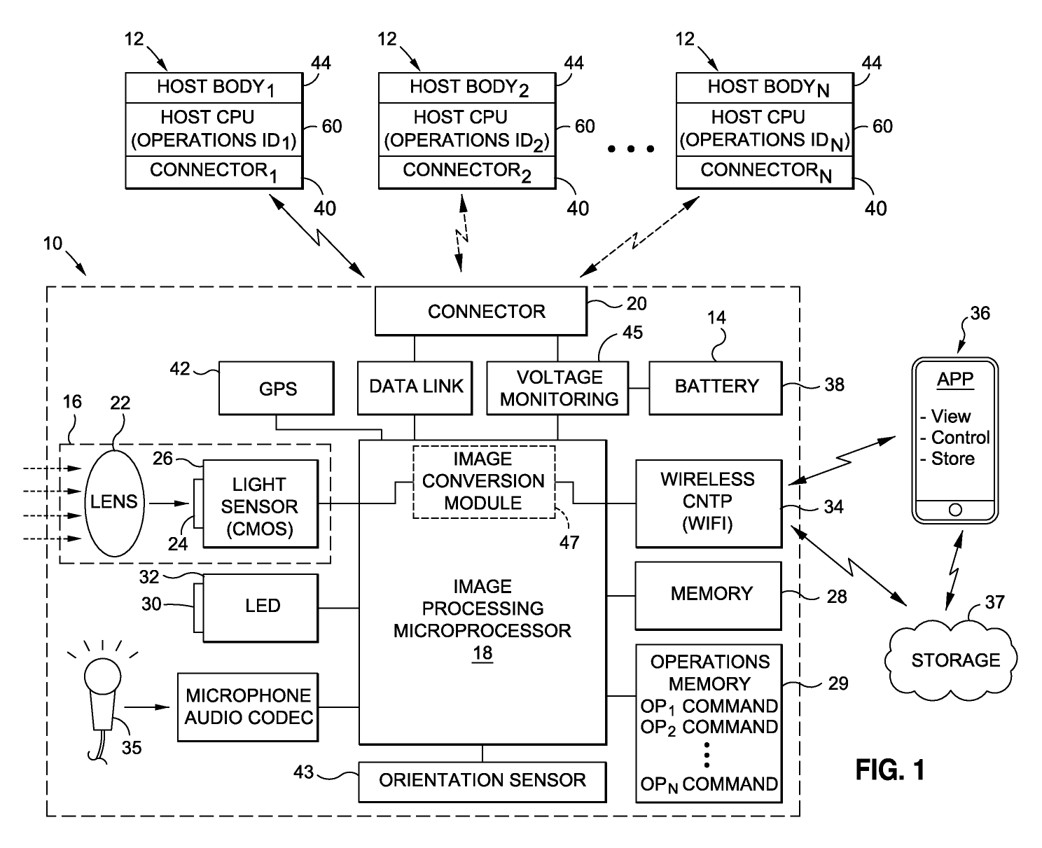

According to one embodiment, and referring to FIG. 1, the camera 10 generally includes a camera housing 14, which houses an image capture assembly 16 and a microprocessor 18 (e.g., processing circuit). A camera connector 20 is coupled to the camera housing 14 and is adapted to operatively couple the camera 10 to a host device 12. The size and shape of the camera housing 14 may vary from one embodiment to the next, and thus, the scope of the camera housing 14 is not limited to a particular size or shape. However, in general, it may be desirable to provide a camera housing 14 that is relatively small and compact to enable easy transport and use of the camera 10. The camera housing 14 may be formed from plastic, rubber, metal or other materials known by those skilled in the art. According to one embodiment, it may be desirable to form a waterproof camera, and thus, the camera housing 14 may be formed from a water resistant material and have waterproof seams at the junction of the camera housing 14 and the connector 20. It is also contemplated that water-proofing of the camera 10 may not require a waterproof camera housing 14, but instead, can be accomplished by connecting the camera 10 to a water proof host device 12 which forms a waterproof enclosure around the camera 10.

According to one embodiment, the image capture assembly 16 is a digital image capture assembly which includes a lens 22, a shutter 24 operatively coupled to the lens 22, and a digital light sensor 26 to digitally capture images/video. According to one embodiment, the sensor 26 is a CMOS (complementary metal oxide semiconductor) sensor, although other camera light sensors known in the art may also be used. The shutter 24, lens 22 and sensor 26 are in optical alignment with each other, with the shutter 24 being selectively moveable relative to the lens 22 between open and closed positions to selectively allow light to pass through the lens 22 and continue to the sensor 26. In particular, when the shutter 24 is in an open position, light passing through the lens 22 may continue to the sensor 26, and when the shutter 24 is in the closed position, light passing through the lens 22 is blocked from the sensor 26. The sensor 26 is in operative communication with a memory device 28 for storing image/video data captured by the sensor 26. The capacity of the memory device 28 may vary from one camera 10 to the next, although preferred memory capacity is 8 GB; however the capacity may be smaller than 8 GB (e.g., 2 GB) or much larger than 8 GB (e.g., 32 GB, 64 GB, 128 GB, etc.). The camera 10 may also include a separate operations memory device 29 in communication with the microprocessor 18 and adapted for storing operational commands/instructions for the various operational modes capable of being executed by the camera 10. According to one embodiment, the operations memory 29 is a Serial Peripheral Interface (SPI) flash memory.

A camera flash sensor 30 and corresponding camera flash (e.g., light emitting diode) 32 may also be included to provide enhanced lighting in dark environments, with the flash sensor 30 being operative to detect dark lighting conditions and generate a signal which actuates the flash 32. The image capture assembly 16 is capable of being operated in a plurality of different operational modes, as will be described in more detail below. A microphone 35 may also be included to capture sound with any video, with microphone encryption/decryption being performed by a microphone audio codec.

In addition to the camera flash 32, the camera 10 may further include status indicator light (e.g., light emitting diode), which provides a visual indication as to the status of the camera 10. For instance, the status indicator light may indicate whether the camera 10 is ON or OFF, in a picture-taking mode or video-mode, etc.

According to one embodiment, the camera connector 20 is the only physical data and/or power port which is exposed on the camera 10, e.g., the only port/connection which requires an opening in a wall of the camera housing 14. In this respect, it is understood that the camera 10 may include additional data ports internal to the camera housing, such as a wireless communication circuit 34 capable of wirelessly communicating data between the camera 10 and a remote device 36, such as a smartphone, as will be described in more detail below. However, the connector 20 is preferably the only structure on the camera 10 which enables direction physical interaction with a remote device, such as a host 12 or a power supply for recharging a battery 38.

According to one embodiment, the microprocessor 18 is located within the camera housing 14 and is operatively coupled to the connector 20 and the image capture assembly 16, with the microprocessor 18 having computer executable instructions (e.g., software) stored thereon to enable the microprocessor 18 to implement functionality associated with the host device 12 upon connection of the camera 10 to the host device 12. In general, the microprocessor 18 is capable of detecting a host device 12 in response to the establishment of a connection between the host connector 40 and the camera connector 20, identify the host device 12 connected to the camera connector 20, identify operational instructions associated with the host device 12 and operate the image capture assembly 16 in accordance with the operational instructions associated with the host device 12.

The wireless communication circuit 34 in the camera 10 is capable of communicating with a remote device 36 and may utilize wireless communication protocols known in the art, such as Bluetooth™, WiFi, or the like, to effectuate such wireless communications. The wireless communications between the camera 10 and the remote device 36 may be for purposes of transmitting image/video data captured by the sensor 26, communicating operational instructions to the camera 10, e.g., programming the camera 10, or establishing wireless connection with a remote host. Furthermore, the wireless communication circuit 34 may also communicate with a remote storage database, e.g., cloud storage 37.

The battery 38 may be provided within the camera housing 14 to provide power during operation of the camera 10. The battery 38 may be rechargeable, wherein recharging may be accomplished by connecting the camera connector 20 to a power source. For instance, an adaptor cable may be used to connect the camera connector 20 with a conventional power outlet. Thus, power may be communicated to the battery 38 through the camera connector 20 for recharging the battery 38. In addition to receiving power from the battery 38, it is also contemplated that the camera 10 may receive power from the host device 12 to which the camera 10 is connected.

The camera 10 may further include a GPS unit 42 to detect geographic position of the camera 10. The geographic position may be a factor used in determining which functionality is implemented by the camera 10. For instance, the camera 10 may be programmed to operate in a first operational mode in a first geographic location and a second operational mode in a second geographic location. Other embodiments of the camera 10 may not include a GPS circuit within the camera housing 14, and thus, may rely on GPS information from a remote device 36, such as a smartphone or a host device 12.

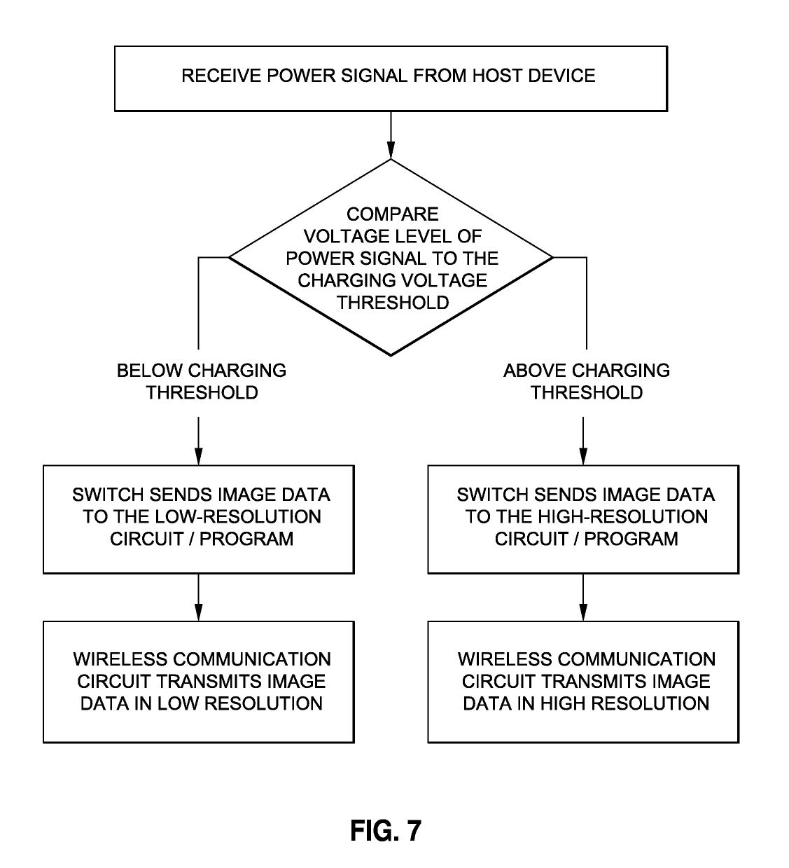

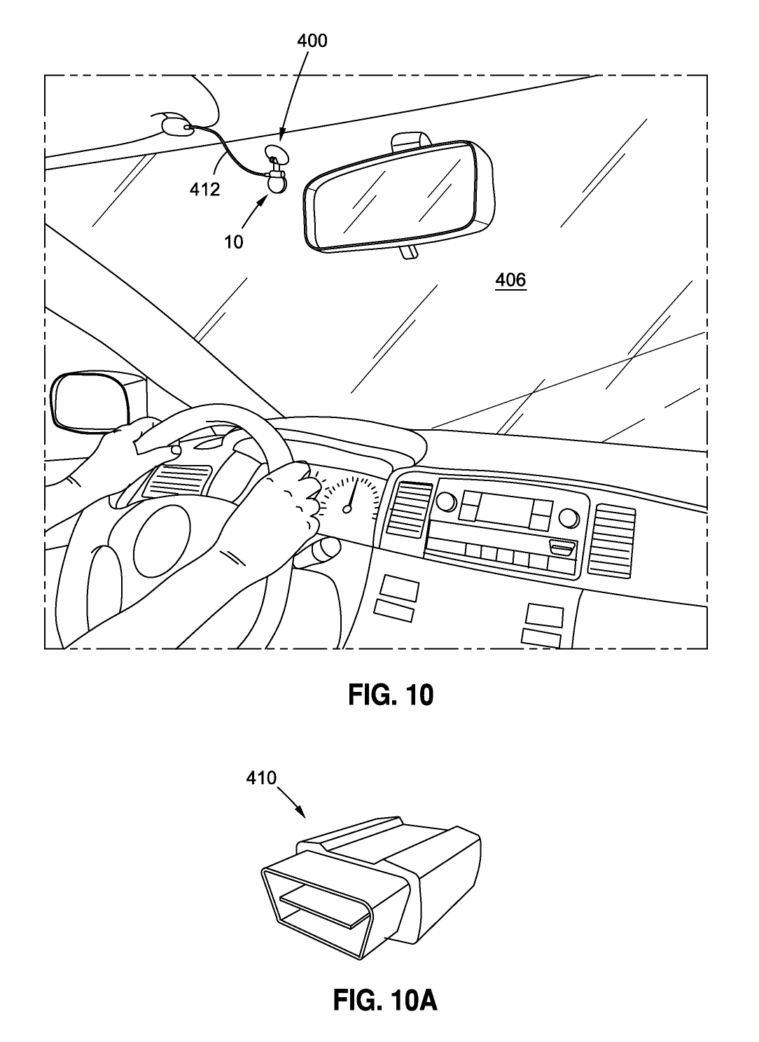

The camera 10 may additionally comprise an orientation sensor 43 for detecting the orientation of the camera 10 relative to a vertical axis. In this respect, it is understood that the camera 10 may be connected to the host device 12 such that the camera 10 extends above the host device 12 (for example, see FIG. 7) and that captured images should be oriented in a first direction, and that the camera 10 may also be connected to the host device 12 such that the camera 10 extends below the host device 12 (for example, see FIG. 10) and that captured images should be oriented in a second direction rotated approximately 180 degrees relative to the first orientation. The rotation of the captured images is preferably executed by the microprocessor 18, although it is also understood that the images may be tagged with a particular orientation identifier, such that the display device (e.g., the smartphone 36) may perform the processing associated with orientation adjustment of the image.

According to one embodiment, the camera 10 includes a voltage monitoring circuit 45 for measuring the voltage of an incoming power signal from a host device 12 connected to the camera 10 via the connector 20. The power signal may be used to charge the camera 10 and/or operate the camera 10. It is also contemplated that the power signal may be used by an image conversion module 47 on the camera 10 to determine the resolution and related transmission speed of image data transmitted by the camera 10, as will be described in more detail below.

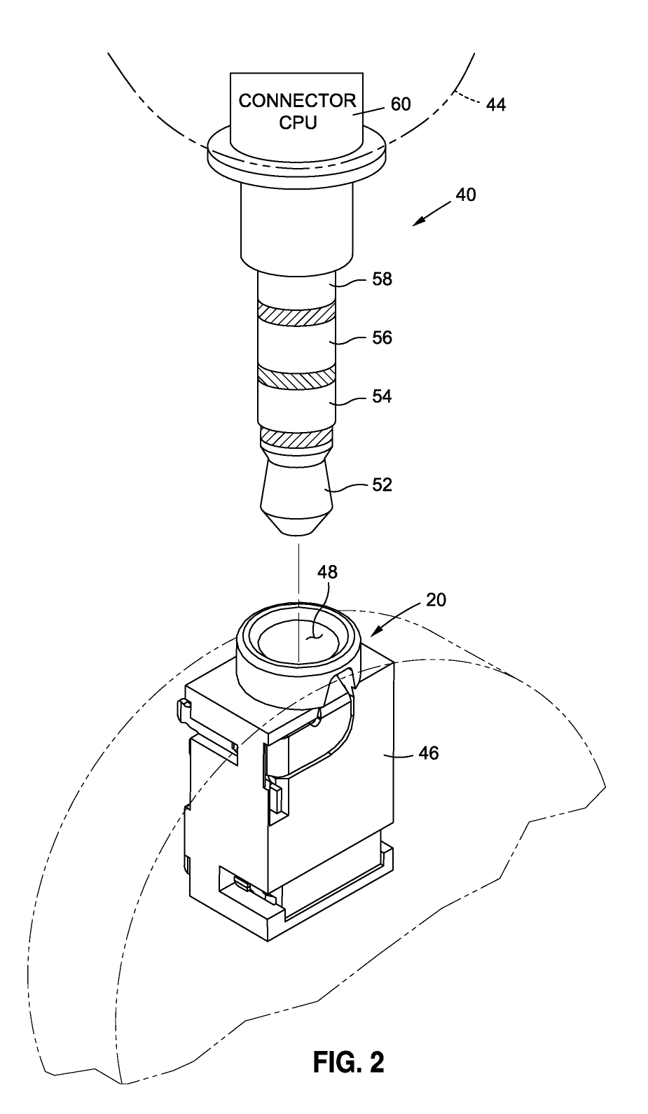

Referring now to FIGS. 2-4, there is depicted an exemplary embodiment of a camera connector 20 and corresponding host connector 40. The camera connector 20 includes a connector housing 46 adapted to be located within the camera housing 14, with the connector housing 46 defining a connector opening 48 complimentary to the host connector 40. The camera connector 20 includes one or more terminals 50 (see FIG. 4) which are electrically connectable to the camera microprocessor 18 to effectuate electrical communication therebetween.

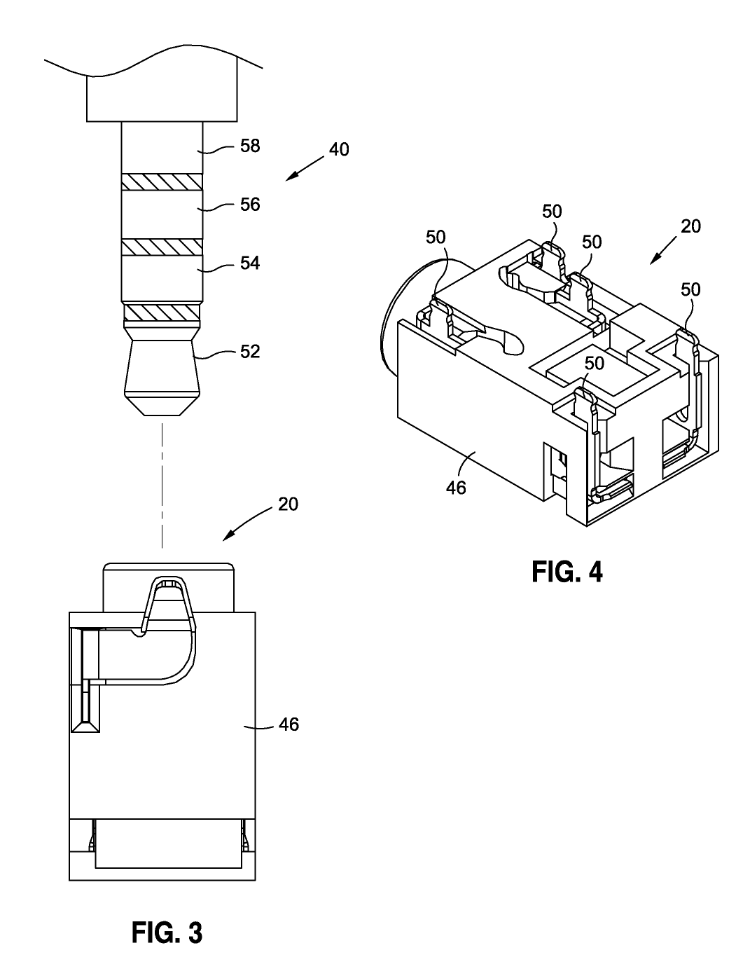

The exemplary host connector 40 shown in FIGS. 2 and 3 is in the form of a pin-like connector which is coupled to a host body 44. The host connector 40 includes a plurality of discrete connector regions 52, 54, 56, 58 and a connector CPU 60 in electrical communication with the connector regions 52, 54, 56, 58. The connector regions 52, 54 may be adapted to communicate power signals between the camera 10 and host device 12, while the connector regions 56, 58 may be adapted to communication data between the camera 10 and the host device 12. The connector CPU 60 is adapted to communicate information to the camera 10 which may be used by the camera 10 to implement an operational mode associated with the host device 12. Along these lines, the connector CPU 60 is configured to generate and transmit an operations signal to the camera 10 upon connection of the host 12 to the camera 10. For instance, the connector CPU 60 may generate and transmit a signal including a mode number upon connection of the camera 10 to the host device 12, with the camera 10 being configured to implement the operational instructions associated with the mode number received by the connector CPU 60. Alternatively, the connector CPU 60 may generate and transmit a signal including an electronic identification number upon connection of the camera 10 to the host device 12, with the camera 10 being configured to identify an operational mode associated with the received electronic identification number, and then implement the operational instructions associated with the identified operational mode. Simply communicating a mode number to the camera 10 may be more straightforward than communicating the electronic identification number, although there may be some benefit associated with the camera 10 knowing the electronic identification number associated with the host device 12. For instance, the camera 10 may be configured to activate/deactivate certain functionality on the camera 10 based on the electronic identification number received from the connector CPU 60. For instance, the camera 10 may activate/deactivate the flash 32 or microphone 35 based on electronic identification number received from the connector CPU 60.

In more sophisticated connector CPUs 60, operational instructions may be stored on the connector CPU 60, which may be communicated to the camera 10 in response to connection between the camera 10 and the host device 12. The connector CPU 60 may receive power from the camera 10 or from a power source (e.g., battery) local to the host device 12.

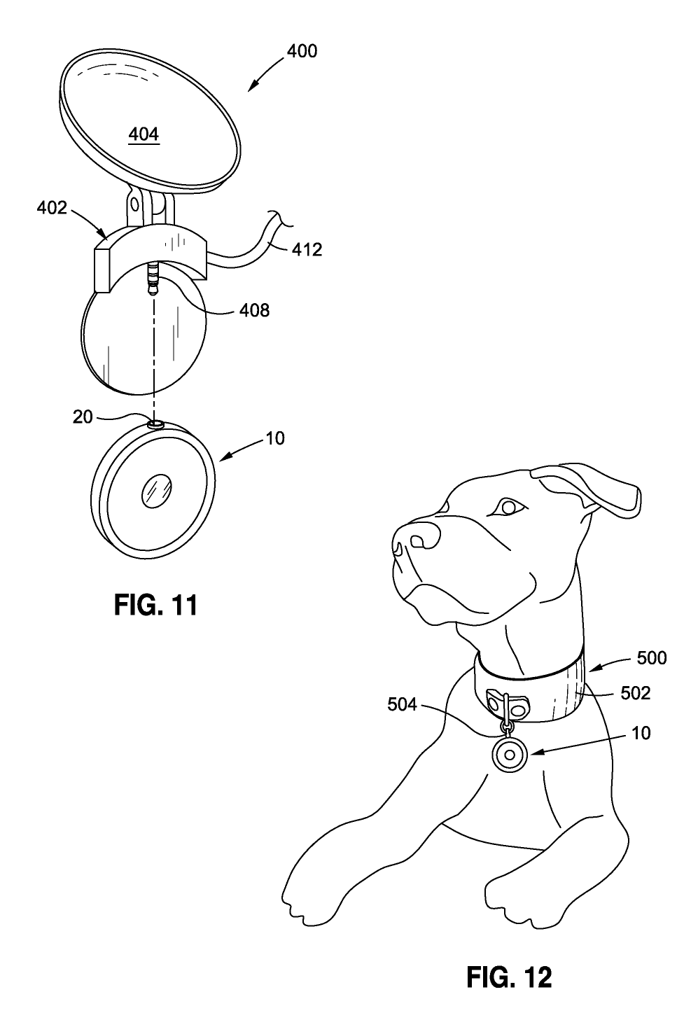

As shown in FIG. 1, the camera 10 is adapted for use with one of plurality of host devices 12. As used herein, the term “host device” broadly encompasses any device which may be physically or wirelessly connected with the camera 10 and which the microprocessor 18 implements certain functionality on the camera 10 in response to such connection. In this respect, the host device(s) 12 may take on many different forms, including, but not limited to, a smartphone case (See FIG. 9), a dashboard camera (See FIGS. 10-11, a wearable item, e.g., pet collar (See FIG. 12), a pin, necklace, belt, hat, shoe, etc., a garden post, a harness for use with sports-related gear, such as a harness attachable to a surfboard, helmet, bicycle, golf bag, drone etc., or a selfie stick.

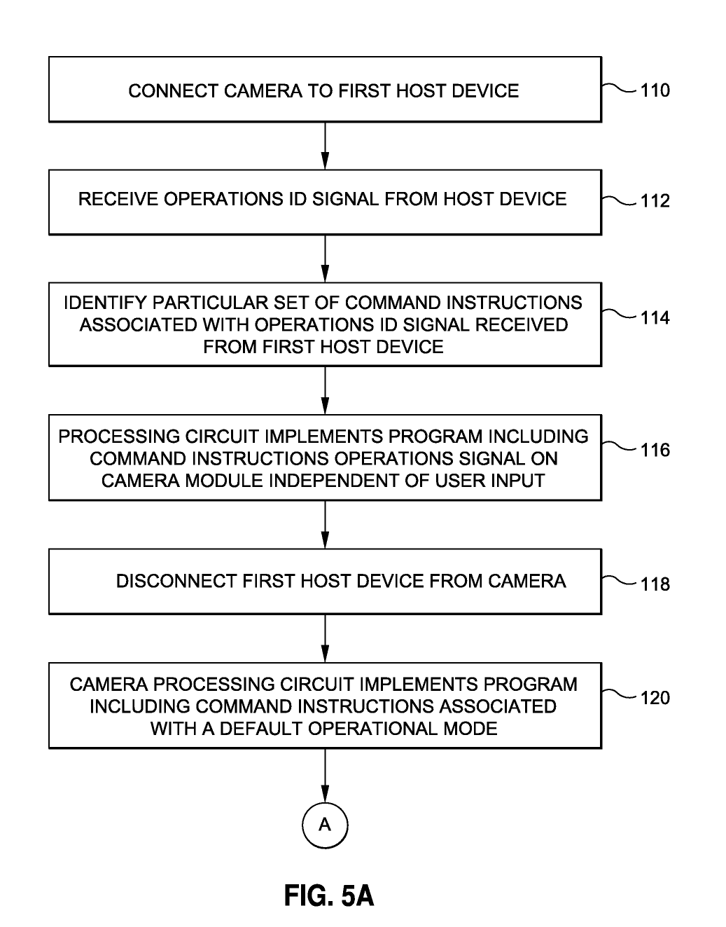

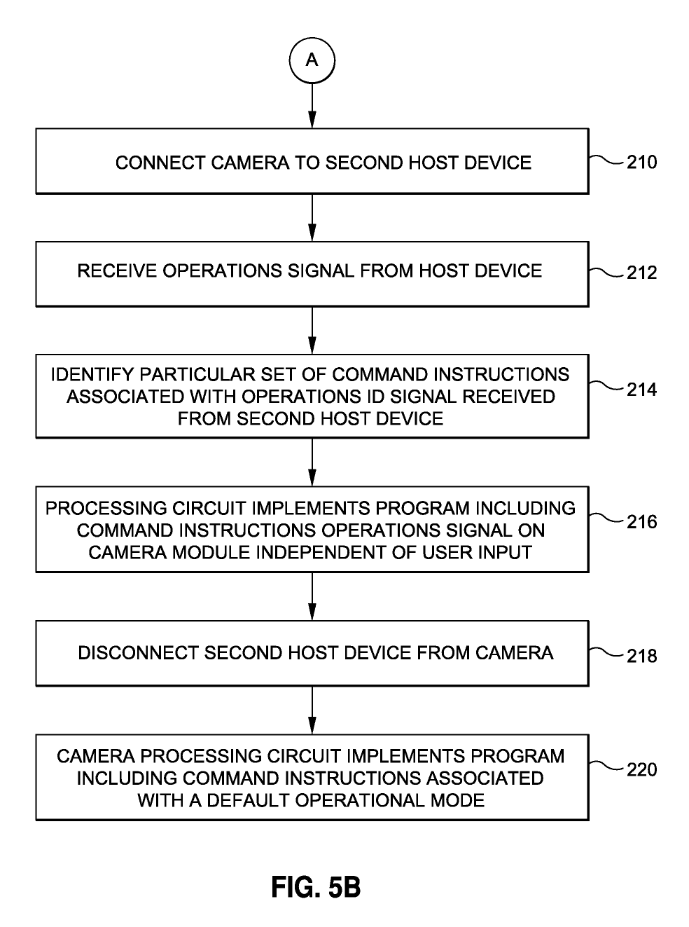

With the basic structure of the camera 10 and host device(s) 12 described above, and referring now to FIGS. 5A-5B, the following discussion will focus on exemplary uses of the camera 10 with the host device(s) 12. Prior to being connected to a host device 12, the camera 10 may be in an OFF state, such that the image capture assembly 16 is either off or dormant and does not capture images or videos. Connecting the camera 10 to a host device 12 at step 110 transitions the camera 10 from the OFF state to an ON state to begin operation.

According to one embodiment, the camera 10 is physically connected to the host device 12 by connecting the host connector 40 to the camera connector 20. The connection of the camera 10 to the host device 12 prompts the host device 12 to communicate an operations identification signal, which is received by the camera 10 at step 112. The host device 12 may be configured to automatically transmit the operations identification signal in response to the connection, or the camera's microprocessor 18 may generate and send a request signal to the host device 12 in response to the connection being made, with the host device 12 being configured to send the operations identification signal in response to receipt of the request signal. The operations identification signal includes information from the host device 12 which is used by the camera 10 to determine which mode or functionality to implement on the camera 10. For instance, the operations identification signal may include the mode number and/or the electronic identification number associated with the host device 12. If the electronic identification number is communicated by the host device 12, the camera 10 identifies which operational mode is associated with that electronic identification number. Although the foregoing describes a mode “number” and electronic identification “number,” it is understood that that the “number” may include an alpha-numeric code, similar to a vehicle identification number.

The microprocessor 18 includes multiple sets of command instructions stored thereon, with each set of command instructions being associated with a respective host device 12 and being operative to command the image capture assembly 16 in accordance with a respective operational mode, such as a video-taking mode or a picture-taking mode, which may include time-lapse, panoramic, various filters, various light settings, etc. The microprocessor 18 identifies the particular set of command instructions associated with the host device 12 based on the operations identification signal received from the host device 12 at step 114. This may entail accessing a database or lookup table having the operational instructions sorted by the identification signals associated with the various host devices 12.

Once the set of command instructions associated with the particular host device 12 is identified, the microprocessor 18 implements those command instructions at step 116 to operate the image capture assembly 16. According to various aspects of the present invention, the camera 10 is capable of operating (i.e., implementation of the command instructions) independent of any input from the user. Thus, once the host device 12 is connected to the camera 10, the camera 10 can operate autonomously. The camera 10 will continue to operate in accordance with the command instructions as long as the camera 10 is connected to the host device 12 and has access to power. With regard to power, the camera 10 may draw power from the battery 38 located on the camera 10, or may receive power from the host device 12. Furthermore, in some instances, the host device 12 may be used to provide power for recharging the battery 38.

Using the method described above, the microprocessor 18 is adapted to implement the particular set of command instructions associated with the host device 12 solely in response to information received from the host device 12 via the connector 20.

When the camera 10 is disconnected from the host device 12 (see step 118), the camera 10 may transition from an ON state to the OFF state. Alternatively, the camera 10 may be programmed to operate in accordance with default operational instructions in response to disconnection of the host device 12 from the camera connector 20 (see step 120). For instance, the camera 10 may be programmed to snap a picture every hour when disconnected form a host device 12.

The camera 10 may remain in the OFF/default state until the camera 10 is connected to a host device 12, which may be the same host device 12 or a different host device 12. FIG. 5B outlines steps 210-220, which are similar to steps 110-120 described above, with the primary distinction being that steps 210-220 relate specifically to the second host device.

It is also contemplated that the camera 10 may be programmed to operate in accordance with default operational instructions when the camera 10 is connected to a host device 12 which is not recognized by the camera 10. In this regard, the camera 10 may include a first set of default operational instructions which are implemented when the camera 10 is disconnected from all host devices, and a second set of operational instructions which are implemented when the camera 10 is connected to a host device 12 which it does not recognize. As such, the camera 10 may be capable of detecting a host device 12 which may be connected to the camera 10, yet not identify such host device 12, e.g., the camera 10 may not recognize the electronic identification number.

During operation of the camera 10, pictures or videos (e.g., image data) captured by the camera 10 may be stored on the memory 28 for subsequent playback, or may be transmitted to a remove viewing device 36 for more real-time viewing/streaming. Subsequent playback or re-time streaming may occur by uploading the image data from the camera 10 to the remote device 36 wirelessly via the wireless communication circuit 34. The remote device 36 may also be used to control/edit the images. It is also contemplated that image data may be uploaded to any digital display device which may be physically connected to the camera 10, wherein image data is uploaded to the digital display device through the connector 20. Furthermore, pictures or videos captured by the camera 10 may be uploaded to a remote storage server 37, which may be cloud-based (accessed via the wireless communication capability of the camera 10 or the smartphone 36). The pictures and videos storage on the remote storage server 37 may be accessed by one or more viewing devices, such as the smartphone 36, for playback.

According to one embodiment, the camera 10 may be configured to autonomously implement certain data processing modes based on the power signal received from the host device 12. Along these lines, the image capturing assembly 16 may capture all image data at a fixed resolution, which is typically a high-resolution (e.g., 12-20 megapixels). Although the camera 10 may be capable of transmitting the image data at the high resolution, in some instances, it may be desirable to transmit the image data at a much lower resolution (e.g., less than 1 megapixel) to enable quicker transmission and display for real-time viewing/streaming. Thus, the camera 10 may be adapted to convert the image data from a high-resolution to a lower-resolution prior to transmission.

In one implementation of the camera 10, such data conversion is performed autonomously based on whether the camera 10 is charging or not, which may be dependent on the magnitude of the power signal (e.g., voltage) received from the host device 10. The camera 10 may have a prescribed voltage threshold which must be reached before charging can occur. In some instances, that voltage threshold is greater than 4 Volts, such that when the host device 12 supplies more than 4 Volts, the battery 38 on the camera 10 may be charged, and when the host device 12 supplies 4 Volts or less, the battery 38 will not be charged. Those skilled in the art will appreciate that the charging voltage threshold may also be less than 4 Volts without departing from the spirit and scope of the present disclosure. When the power signal received from the host device 12 is greater than the voltage threshold, the camera 10 may proceed with transmitting image data at the high resolution. On the other hand, when the power signal received from the host device 12 is less than the voltage threshold, the camera may proceed with converting the image data to a lower resolution for quicker transmission.

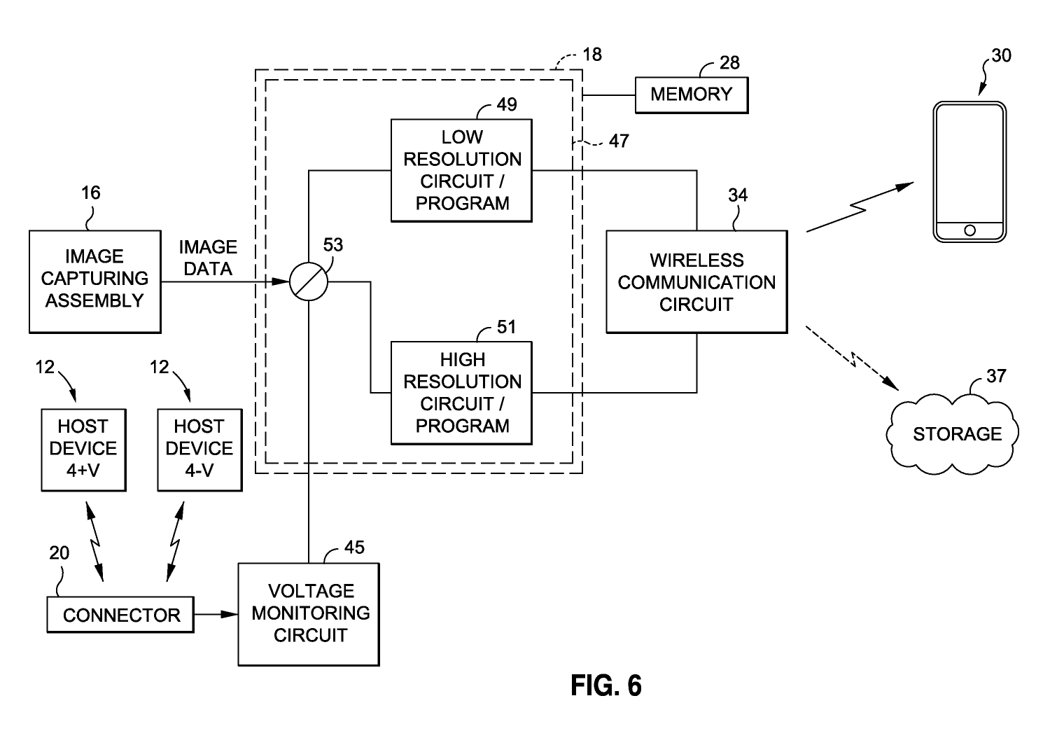

Referring now to FIGS. 6 and 7, there is depicted a schematic diagram of the image conversion module 47 (FIG. 6) and a related flow chart (FIG. 7) related to the image conversion process. According to one embodiment, the image conversion module 47 includes a low resolution circuit 49, a high resolution circuit 51, and a switch 53 operatively coupled to both the low and high resolution circuits 49, 51, as well as the voltage monitoring circuit 45. When the host device 12 is connected to the camera 10, the camera 10 receives a power signal from the host device 12. The voltage monitoring circuit 45 compares the voltage level associated with the power signal to the charging voltage threshold. If the power signal voltage level is above the charging voltage threshold, the switch 53 places the image capturing assembly 16 in operative communication with the high resolution circuit 51, such that image data generated by the image capturing assembly 16 remains at high resolution when it is transmitted via the wireless communication circuit 34. If the power signal voltage level is below the charging voltage threshold, the switch 53 places the image capturing assembly 16 in operative communication with the low resolution circuit 49, such that image data generated by the image capturing assembly 16 is converted from a high resolution to a low resolution before the converted image data is transmitted from the wireless communication circuit 34. Therefore, the switch 53 may oscillate between communicating the image data from the image capturing assembly 16 to the low resolution circuit 49 and the high resolution circuit 51 based on the voltage level of the power signal received by the host device 12.

The low resolution circuit 49, high resolution circuit 51, and switch 53 may employ hardware and/or software known by those skilled in the art for implementing the specific functionalities associated therewith.

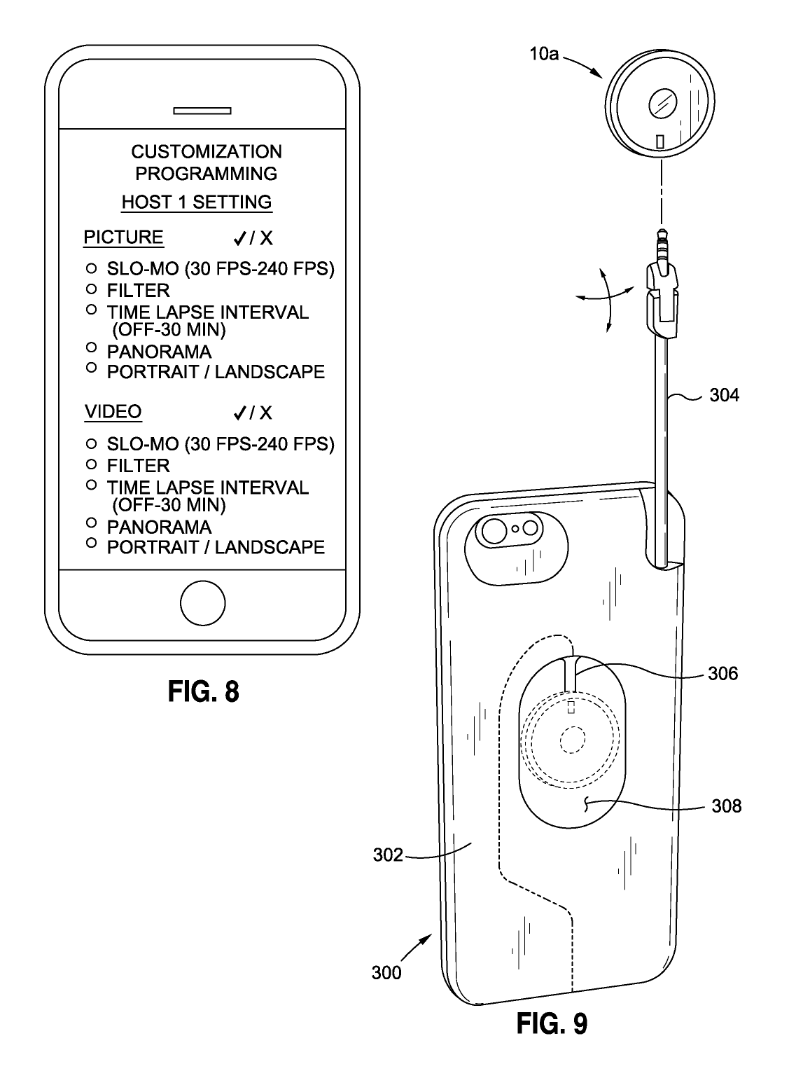

Referring now to FIG. 8, it is contemplated that a user may utilize a remote device for programming the camera 10. For instance, the user may utilize a smartphone, tablet computer, smart watch, laptop computer, desktop computer, smartwatch, or another electronic device for programming the camera 10. Such programming may include providing/inputting/selecting a certain set of operational instructions (e.g., an operational mode) for use with a particular host device 12. The programming on the remote device may be facilitated through an application, e.g., an “app.,” which provides the software necessary to execute the programming on the remote device. The app. may be specifically associated with the camera and may be downloaded from an “app. store” or other similar digital marketplace.

On a smartphone, tablet computer, or other electronic device having a touch screen user interface, the user may navigate through the programming process by making gestures on the touchscreen. However, other modes of user input, such as a mouse, may also be used to make programming selections.

FIG. 8 shows a screenshot of a smartphone, which allows the user to program the camera 10 to operate when “Host 1” is connected to the camera 10. For instance, the user may select a picture-taking function, a video-taking function, or a combination thereof. For instance, the camera may operate in a picture taking mode for a first period of time, and a video taking mode for a second period of time. In this respect, the user may define the start and stop times for taking pictures and videos. Furthermore, with respect to the picture-taking function, the user may select certain options, such as taking a panorama picture (or a standard picture, which is the default), as well as taking pictures at predefined time intervals, e.g., time lapse. For instance, the camera may take a picture every 30 seconds, 1 minute, 2 minutes, 10 minutes, 1 hour, 1 day, or any other time interval defined by the user.

Although not shown in FIG. 8, the user may also make selections regarding the light within which the camera may be used, such as at a beach, during dusk or dawn, or in a snowy environment. The user may also select an “auto” setting, which causes the camera to automatically detect the preferred light setting based on detected lighting conditions. As such, the camera may include a sensor for detecting light, and have a lighting circuit for implanting the preferred light mode based on the detected lighting conditions.

Although FIG. 8 shows programming for one particular host device 12 it is understood that similar programming may be performed on the remote device in connection with other host devices.

The camera 10 described herein may find widespread applicability and may be used with a plurality of different host devices 12. FIGS. 9-12 depict several exemplary embodiments of host devices adapted for use with the camera. Referring now specifically to FIG. 9, there is depicted a smartphone case 300 specifically configured and adapted for use with camera 10. The smartphone case 300 includes a protective housing 302 adapted to protect a smartphone. Attached to the protective housing 302 is a telescoping extension arm 304 having a host device connector (as explained in detail above) attached to the distal end thereof and adapted to connect with the camera connector (as explained in detail above) formed on the camera 10. The camera 10 is configured to operate in accordance with prescribed operating instructions specifically associated with the smartphone case 300 when the camera 10 is connected to the smartphone case 300. The extension arm 304 of the case 300 physically supports the camera 10, and allows the position of the camera 10 relative to the protective housing 302 to be selectively varied by the user. In particular, the extension arm 304 may be extended to move the camera 10 away from the protective housing 302, or retracted to move the camera 10 closer to the protective housing 302. The distal end portion of the extension arm 304 may also be configured to enable selectively pivoting of the camera 10 about one or more axes.

According to one embodiment, the extension arm 304 may be electrically isolated from the smartphone located within the case 300, and thus, the camera 10 may rely on a dedicated battery for operation when connected to the extension arm 304. Furthermore, any data communication between the camera 10 and the smartphone may be effectuated via wireless (e.g., Bluetooth™, WiFi, etc.) communication. However, in other embodiments, the extension arm 304 may be electrically connectable to the smartphone via an electrical port formed on the smartphone.

The smartphone case 300 may also include a second host device connector 306 which is electrically connected to the smartphone when the smartphone is positioned within the case 300. The second host device connector 306 extends into an opening 308 formed in the case 300, with the opening 308 being sized to receive the camera 10 for stowing the camera 10 in the case 300. The second host device connector 306 is electrically connected to the smartphone via communication pathway 310, which enables data and power transfer between the camera 10 and the smartphone. In some instances, a limited amount of power and data may be communicated between the smartphone and the camera 10, which would inhibit the camera 10 from relying solely on the smartphone as a source of power during operation of the camera 10. However, such power and data transfer may be effective for powering the camera 10 overnight, or during long periods of non-use. In this regard, the camera 10 may be programmed to operate in a charging mode when connected to the second host device connector 306.

Referring now to FIGS. 8-9 another exemplary host device 400 is shown which converts the camera to into a “dash-cam,” e.g., a camera located near the dashboard of the vehicle. The host device 400 includes a host body 402 attachable to the windshield, dashboard or other structure of the vehicle either via adhesion or suction. The device 400 shown in FIGS. 8-9 includes a suction cup 404 adapted to be secured to the windshield 406. A host connector 408 is coupled to the host body 402 and is adapted to be connected with the camera connector 20 formed on the camera. The camera 10 is programmed to operate in accordance with prescribed operational instructions associated specifically with the host device 400 when the camera 10 is connected to host connector 408. For instance, the camera may be programmed to take video or time-lapse images during operation of the vehicle.

The host device 400 may be in communication with a vehicle diagnostic port (e.g., an OBD-II port) via a diagnostic device, such as a dongle 410 adapted to interface with the vehicle's ECU. The communication between the host device 400 and the dongle 410 may be via wire 412, which may enable the camera 10 to operate via power from the vehicle. Furthermore, in addition to capturing images/video, the system (including the camera 10 and dongle 410) is also capable of retrieving operational information from the vehicle, which may be superimposed on the images/video during playback. Thus, a view of the images/video will be capable of viewing the image/video captured by the camera 10 along with operational data (RPM, speed, braking information, etc.) in a single field of view.

The use of the dongle 410 allows the camera system depicted in FIG. 10 to be triggered in connection with operational information associated with the vehicle. For instance, the camera may be configured to start capturing images (e.g., pictures or video) when certain operational triggers or thresholds are met, with the dongle having access to the vehicle's ECU to retrieve such operational data. In one instance, the camera may be turned on when the vehicle speed exceeds a prescribed value (e.g., 45 MPH). The In another instance, the camera may be configured to buffer image data for a certain period of time (e.g., 2 minutes), and then store that buffered image data in a long term memory module in response to a prescribed trigger, such as the airbag data, brake data, RPM data, speed data, acceleration data, etc. In this respect, the dongle 410 provides a communication link between the vehicle ECU and the camera 10 to enable the camera 10 to operate in response to real-time operational conditions of the vehicle.

Referring now to FIG. 12, there is depicted another embodiment of a host device 500 in the form of a dog collar. The host device 500 includes a collar body 502 wearable around the pet's neck, and a host device connector 504 connectable to the camera 10. The camera 10 is programmed to operate in accordance with prescribed operational instructions associated specifically with the host device 500 when the camera 10 is connected to host device 500. In this regard, host device 500 allows a pet owner to capture images/video of where the pet moves throughout the day.

Although the host device 500 is shown in the form of a pet collar, it is understood that the host device may include other wearable devices, which are not only wearable by animals, but also by human users. The wearable device may orient the camera 10 in a defined direction (e.g., forward facing) when the camera 10 is connected thereto, or the device may have the ability to “aim” the camera 10 in a particular direction. In either event, the user may be able to capture picture/video content from the camera 10 without having to deliberately stop and take a picture or video. This may be particularly desirable in a social setting, e.g., a party, to autonomously capture images throughout the event.

A further exemplary host device (not shown) may be an attachment which may be worn/carried by a child, wherein the camera 10 may function as a security camera. For instance, the host device may be an attachment to a backpack, a belt, a shoe, etc.

It is also contemplated that a host device (not shown) may include a waterproof enclosure for the camera 10 to allow the camera to be used underwater. For instance, the camera 10 may capture images while snorkeling, surfing, body boarding, scuba diving, stand-up paddle boarding, etc.

It is understood that the foregoing examples of host devices and uses of the camera 10 are exemplary in nature only and do not limit the scope of the possible host devices or possible uses of the camera 10. Rather, the camera 10 is specifically configured for a wide range of uses with an open-ended number of host devices.

Furthermore, the foregoing describes that camera 10 as including the hardware and software necessary for identifying the connected host device and determining the operational mode associated with the connected host device. In this respect, there may be some economies in placing such hardware and software in the camera 10, which would allow the host devices to be less sophisticated. However, it understood that more sophisticated host devices may be used, which essentially program the camera 10 upon connection of the host device to the camera 10. For instance, the host device may include a set of operational instructions stored thereon, wherein the set of operational instructions may be communicated to the camera 10 in response to connecting the host device to the camera 10. The camera 10 may be configured to receive the operational instructions from the host device and implement the functionality associated with the operational instructions.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

1. A method of operating an image capture assembly in connection with a host device, the method comprising the steps of:
receiving an operating signal associated with a first host device at a camera, the camera having:
an image capture assembly capable of being operated in a first operational mode and a second operational mode; and
a microprocessor in operative communication with the image capture assembly and adapted to execute computer executable instructions for operating the image capture assembly in one of the first operational mode and the second operational mode based on the operating signal received by the camera; and
determining which one of the first operational mode and the second operational mode is associated with the first host device based on the operational signal received by the camera; and
operating the image capture assembly in the one of the first operational mode and the second operational mode determined to be associated with the first host device.

2. The method recited in claim 1, wherein the first operational mode includes a picture-taking mode.

3. The method recited in claim 2, wherein the second operational mode includes a video-taking mode.

4. The method recited in claim 1, wherein the operating signal in the receiving step includes identifying information associated with the first host device.

5. The method recited in claim 1, wherein the operating signal includes information identifying one of the first operational mode and the second operational mode as being associated with the first host device.

6. A method of operating an image capture assembly in connection with a host device, the method comprising the steps of:
receiving a first identification signal associated with a first host device at a processing circuit located within a camera housing, the processing circuit having multiple sets of command instructions stored thereon, each set of command instructions being associated with a respective host device and being operative to command the image capture assembly in accordance with a respective operational mode;
identifying the particular set of command instructions associated with the first host device based on the first identification signal received therefrom; and
operating the image capture assembly in accordance with the identified set of command instructions associated with the first host device.

7. The method recited in claim 6, wherein the operating step proceeds independent of any input from a user.

8. The method recited in claim 6, wherein the operating step occurs autonomously in response to completion of the identifying step.

9. The method recited in claim 6, wherein the first identification signal is received at the processing circuit in response to connecting the camera housing to the first host device.

10. The method recited in claim 9, further comprising the step of operating the image capture assembly in accordance with default operational instructions in response to disconnection of the first host device from the camera housing.

11. The method recited in claim 6, wherein the operating step includes operating the image capture assembly in a video mode.

12. The method recited in claim 6, wherein the operating step includes operating the image capture assembly in a picture-taking mode.

13. The method recited in claim 12, wherein the operating step includes operating the image capture assembly in a time-lapse picture taking mode.

14. The method recited in claim 6, wherein the first host device is a GPS unit associated with the camera housing, the first identification signal being received at the processing circuit in response to the camera housing being within a prescribed geographic location.

15. The method recited in claim 6, further comprising the steps of:
receiving a second identification signal associated with a second host device at the processing circuit located within the camera housing;
identifying the particular set of command instructions associated with the second host device based on the second identification signal received therefrom; and
operating the image capture assembly in accordance with the identified set of command instructions associated with the second host device.

16. The method recited in claim 6, further comprising the step of receiving a power signal from the first host device.

17. A camera adapted for use with a host device, the camera comprising:
a camera housing;
an image capture assembly coupled to the camera housing and including a lens, the image capture assembly being capable of operating in a plurality of operational modes;
a connector coupled to the camera housing and configured to be selectively connectable to a first host device; and
a processing circuit operatively coupled to the connector and the image capture assembly, the processing circuit having computer executable instructions stored thereon to enable the processing circuit to:
operate the image capture assembly in accordance with the respective one of the plurality of operational modes associated with the first host device in response to connection of the connector to the first host device.

18. The camera recited in claim 17, wherein the computer executable instructions stored on the processing circuit enable the processing circuit to identify the first host device when the first host device is connected to the connector.

19. The camera recited in claim 17, wherein the computer executable instructions stored on the processing circuit enable operation of the image capture assembly in the first one of the plurality of operational modes associated with the first host device independent of any input by a user.

20. The camera recited in claim 17, wherein the computer executable instructions stored on the processing circuit enable operation of the image capture assembly in the first one of the plurality of operational modes associated with the first host device autonomously in response to identification of the first host device.

21. The camera recited in claim 17, formed independent of a button in operative communication with the processing circuit.

22. The camera recited in claim 17, wherein the computer executable instructions stored on the processing circuit is adapted to identify the first host device solely in response to information received from first host device via the connector.

23. The camera recited in claim 17, wherein the processing circuit is located within the camera housing.

24. A camera system comprising:
a host device including:
a host connector; and
a host processor in communication with the host connector and adapted to generate an operating signal;
a camera selectively connectable to the host device and comprising:
a camera housing;
an image capture assembly coupled to the camera housing and including a lens and shutter, the image capture assembly capable of being operated in a plurality of operational modes;
a camera connector coupled to the camera housing and configured to be selectively connectable to the host connector; and
a processing circuit operatively coupled to the camera connector and the image capture assembly, the processing circuit receiving the operating signal from the host processor via the camera connector and the host connector in response to connection therebetween, the processing circuit having computer executable instructions stored thereon to enable the processing circuit to:
operate the image capture assembly in accordance with the operating signal received from the host device.

25. A method of operating a camera in connection with a host device, the method comprising the steps of:
receiving a power signal from the host device at the camera having:
an image capture assembly capable of being operated in a first operational mode and a second operational mode to generate image data at an image capture size;
an image conversion module capable of converting the image data from the image capture size to a transmission size; and
a microprocessor in operative communication with the image capture assembly and adapted to execute computer executable instructions for:
operating the image capture assembly in one of the first operational mode and the second operational mode based on information received from the host device; and
determining the transmission size based on the power signal received from the host device;
operating the image capture assembly in accordance with one of the first operational mode and the second operational mode associated with the host device to generate the image data; and
determining the transmission size for transmission to a remote device, the transmission size of the first signal being low-resolution when the power signal is below a prescribed voltage threshold and the transmission size of the first signal being high-resolution when the power signal is above the prescribed voltage threshold.

26. The method recited in claim 25, wherein the prescribed voltage threshold is approximately 4 Volts.

27. The method recited in claim 25, wherein the transmission size being low-resolution allows for real-time streaming of the first signal.

28. The method recited in claim 25, wherein the transmission size being high-resolution enables file storage of the first signal at the remote device.

29. The method recited in claim 25, further comprising the step of capturing image data at high-resolution.

30. The method recited in claim 25, wherein the prescribed voltage threshold is associated with a charging voltage of the camera.

31. The method recited in claim 25, wherein the remote device includes a smartphone.

32. The method recited in claim 25, wherein the remote device includes a router associated with cloud-based data storage.

33. The method recited in claim 1, further comprising the step of receiving a programming signal from a user, the programming signal including specified operational instructions associated with the one of the first operational mode and the second operational mode associated with the first host device.
